(19) United States
(12) Patent Application Publication
(10) Pub. No.: US 2005/0040943 A1
(43) Pub. Date: Feb. 24, 2005

(54) RF interconnected HVAC system and security system

(75) Inventor: Steven J. Winick, Woodmere, NY (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., MORRISTOWN, NJ (US)

(21) Appl. No.: 10/646,642

(22) Filed: Aug. 22, 2003

(51) Int. Cl. G08B 1/08

(52) U.S. Cl. 340/539.1

(57) ABSTRACT

An interconnected wireless RF HVAC (heating, ventilation, air conditioning) system and wireless RF security system, which are interconnected and communicate with each other through the use of a common wireless RF technology, including the same selected frequency, modulation and a set of common protocols. The RF wireless HVAC system includes wireless RF thermostats which can communicate with and control both the HVAC system and the security system, and the wireless RF security system includes wireless RF controls or keypads which can communicate with and control both the security system and the HVAC system. The universal RF infrastructure can be expanded to provide communication or control of additional user or manufacturer installed wireless RF devices or systems through the universal RF home infrastructure.

### BACKGROUND OF THE INVENTION

1. Field of the Invention

The present invention relates generally to an interconnected HVAC (heating, ventilation, air conditioning) system and security system, and more particularly pertains to an interconnected wireless RF HVAC system and wireless RF security system which are interconnected and communicate with each other through the use of a common wireless RF technology, including the same selected frequency, modulation and a set of common protocols.

The RF wireless HVAC system includes wireless RF thermostats which can communicate with and control both the HVAC system and the security system, and the wireless RF security system includes wireless RF control keypads which can communicate with and control both the security system and the HVAC system. Moreover, the universal RF infrastructure can be expanded with additional user or manufacturer installed wireless RF devices or systems to provide communication or control of the additional user or manufacturer installed wireless RF devices or systems through the universal RF home infrastructure.

2. Discussion of the Prior Art

In the present state of the art, there is no simple and effective way to interconnect an HVAC system, which is typically controlled by thermostats, with a security system, which is typically controlled by keypads. This problem with interconnectivity is made even more complex when the realities of market distribution channels are considered and recognized. For example, a security installation company typically is not willing to install anything that affects the home HVAC (heating, ventilating, air conditioning) system or to connect to or program an HVAC system. Similarly, an HVAC installer typically is not willing to install anything that affects the home security system or to connect to or program a security system. Moreover, neither type of installer is willing to install a bridging device between the security system and the HVAC system.

Programmable thermostats are commonly available at the present time, but share a common problem. Their user interfaces are generally very basic and simple, making programming and usage difficult, such that most users cannot take full advantage of the features and functions of the programmable thermostats. In addition, present thermostats are limited in the extent of the information they can display, typically confined to the temperature set points and the currently sensed temperature. They can't sense or display the temperature in other rooms, outdoor temperature, or air quality for example. In addition, present thermostats cannot be remotely controlled from other rooms or from mobile locations within a home, and are typically limited to regulating temperature based on sensed information at the thermostat location. The prior art literature also discloses thermostats for HVAC systems provided with a GUI (graphical user interface), and thermostats communicating with an HVAC system by a short range RF transceiver.

### SUMMARY OF THE INVENTION

Accordingly, it is a primary object of the present invention to provide an interconnected HVAC (heating, ventilation, air conditioning) system and security system.

The HVAC system incorporates an RF (radio frequency) wireless control system using a selected RF frequency, modulation and a set of protocols, and includes at least one wireless RF thermostat having an RF transceiver for communicating with and controlling the HVAC system. The HVAC system can also incorporate one or more wireless CO sensors and wireless smoke or fire detectors.

The security system also incorporates an RF wireless control system using the same selected RF frequency and modulation as the HVAC RF wireless control system, and also using a set of protocols which includes a set of common protocols which are common to both the HVAC system and the security system. The security system further includes at least one wireless RF control keypad for communicating with and controlling the security system. The security system can also incorporate one or more wireless CO sensors and wireless smoke or fire detectors. Pursuant to the present invention, the common RF frequency, modulation and set of common protocols provide interconnectivity and communication between the HVAC system and the security system.

In greater detail, the HVAC system is controllable from the security system wireless RF keypads, and the security system is controllable from the wireless RF thermostats. The security system includes room occupancy sensors, typically IR sensors for sensing the presence of occupants in rooms, and the room occupancy sensors of the security system can advantageously be used to control the HVAC system, such as to set back the regulated temperature of a room when the room is not occupied. In different embodiments, either the HVAC system or the security system, or both the HVAC system and the security system, can incorporate wireless CO sensors and/or wireless smoke or fire detectors. In an embodiment wherein the security system incorporates wireless CO sensors and wireless smoke or fire detectors, and the HVAC system does not, when the security system reports a fire event, the HVAC system can advantageously use the reported information to turn itself off, and when the security system reports a CO event, the HVAC system can advantageously use the reported information to turn itself on.

A typical HVAC system can include a plurality of different regulated zones, with each zone controlled by a separate thermostat installed in the zone. The present invention can include a plurality of separate wireless RF thermostats, and each wireless RF thermostat can discover and communicate with each other wireless RF thermostat, to permit adjustment and display of any one wireless RF thermostat's conditions from any of the other wireless RF thermostats.

Pursuant to the present invention, each wireless RF thermostat preferably includes a GUI (graphical user interface) to provide an easily programmable thermostat to allow a user to take full advantage of the programmable features and functions of the programmable thermostat. In addition, each wireless RF thermostat and GUI is not limited in the extent of the information which can be displayed, and can display, for example, the temperature of another room, the outdoor temperature, or the air quality. One or more of the thermostats or wireless remotes can incorporate an easily programmable feature whereby, by merely pressing a button switch one or more times, the temperature of the zone controlled by the thermostat or wireless remote can be set back for a period of time determined by the number of times the switch is depressed. In addition, the wireless RF thermostats can be remotely controlled by other wireless RF thermostats in other rooms or from mobile locations within a home.

### BRIEF DESCRIPTION OF THE DRAWINGS

The foregoing objects and advantages of the present invention for an interconnected HVAC system and security system may be more readily understood by one skilled in the art with reference being had to the following detailed description of several embodiments thereof, taken in conjunction with the accompanying drawings wherein the elements are designated by identical reference numerals throughout the several views, and in which:

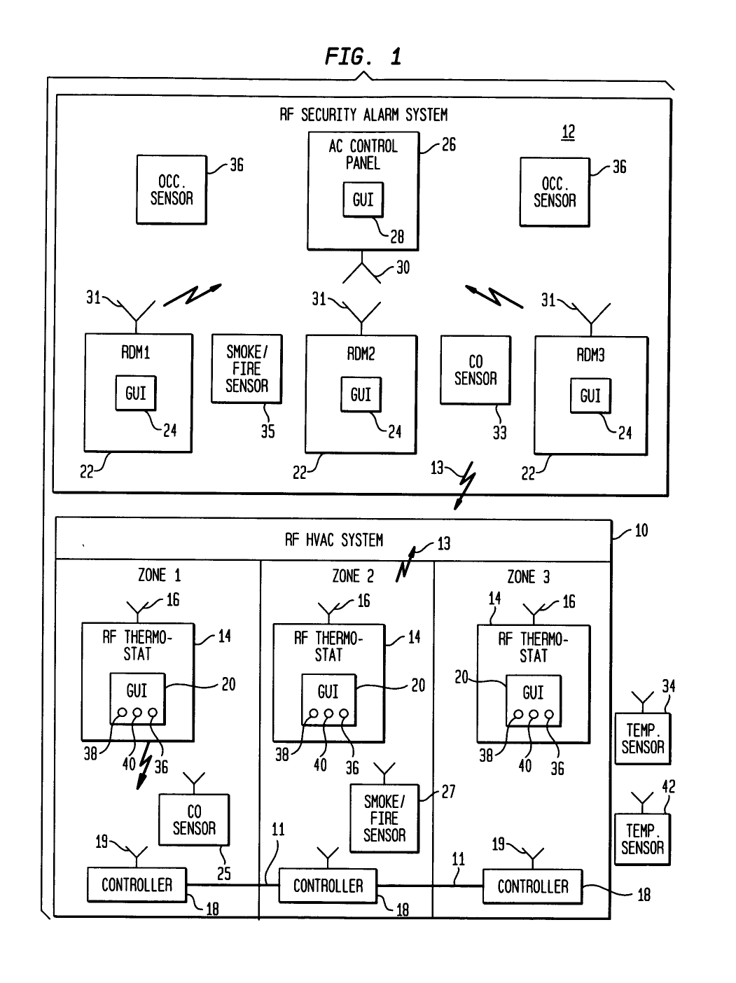

The bottom of FIG. 1 illustrates an HVAC system incorporating an RF wireless control system using a selected RF frequency, modulation and set of protocols which includes a plurality of wireless RF thermostats, generally one for each zone of the HVAC system, with each thermostat having an RF transceiver for communicating with and controlling the HVAC system, and the top of FIG. 1 illustrates a security system also incorporating an RF wireless control system, using the same selected RF frequency, modulation and a common set of protocols as the HVAC RF wireless control system, which includes a plurality of wireless RF controllers in remote display modules (RDMs) for communicating with and controlling the security system.

### DETAILED DESCRIPTION OF THE INVENTION

The present invention provides an interconnected wireless RF HVAC system 10 and wireless RF security alarm system 12 which are interconnected and communicate with each other by RF signals 13 through the use of a common wireless RF technology, including the same selected frequency, modulation and a set of common protocols.

The bottom of FIG. 1 illustrates a wireless RF HVAC system 10 incorporating an RF (radio frequency) wireless control system using a selected RF frequency, modulation and a set of protocols. A typical modem HVAC system communicates over a local network via a local network system bus 11, with different components of the HVAC system having different digital addresses in the local network. The wireless RF HVAC system typically includes a plurality of n zones, shown as zones 1, 2 and 3, and a plurality of wireless RF controls 14 which can comprise enhanced RF thermostats, generally one for each zone of the HVAC system. Each enhanced control or thermostat has a short range RF transceiver and antenna 16 for communicating with and controlling a controller 18 having an antenna 19 of the wireless RF HVAC system and also other components as explained herein. Each thermostat 14 of the HVAC system is also enhanced with a graphical user interface (GUI) 20, such that it can be programmed to include conventional thermostat functionality with a user-friendly presentation. The enhanced thermostat permits easy user interaction and provides the ability to display and integrate various accessory sensors and remote controls. The HVAC system can also incorporate one or more wireless CO sensors 25 and one or more wireless smoke or fire detectors 27.

The top of FIG. 1 illustrates the wireless RF security alarm system 12 which also incorporates an RF wireless control system using the same selected RF frequency and modulation as the wireless RF HVAC control system 10. The security system 12 also uses a set of protocols which includes a set of common protocols which are common to both the HVAC system and the security system. The wireless RF security alarm system 12 includes a plurality of wireless RF controls in the form of Remote Display Modules (RDMs) 22, each having a keypad or a GUI 24, for communicating with and controlling the security alarm system and also other components as explained herein.

The wireless RF security alarm system can be a system such as an Ademco security alarm system wherein an AC powered control panel 26, such as an Ademco Quickmate™ control panel, is provided at a central accessible location, such as at an entrance to a building protected by the security alarm system. The control panel 26 can provide a display of all pertinent parameters and conditions of the security alarm system, and also provides inputs, such as a Graphical User Interface (GUI) 28, to allow a user to view the status of the security alarm system and also to enter data into and access and control the security alarm system.

The control panel also includes a local RF transceiver and antenna 30 to transmit periodic RF messages on the present status of the security alarm system to the plurality of battery powered Remote Display Modules (RDMs) 22 provided at a plurality of locations throughout the building. Each battery powered RDM 22 includes an RF transceiver and antenna 31 to receive the local RF transmissions from the transmitter at the control panel, such that each wireless keypad RDM can also provide an accurate display of the present status of the security alarm system, and also to transmit RF signals to the control panel 26 to communicate with and control the wireless RF security alarm system.

The wireless RF security alarm system can also include one or more wireless RF CO sensors 33 and one or more wireless RF smoke or fire detectors 35.

Pursuant to the present invention, the common RF transceiver technology, including common RF frequency, modulation and the set of common protocols, provide interconnectivity and communication between the HVAC system 10 and the security alarm system 12. The common RF transceiver technology provides control of the wireless RF HVAC system 10 from either the enhanced wireless RF thermostats 14 or the security system wireless RF RDMs 22, and also provides control of the wireless RF security alarm system from either the security system wireless RF RDMs 22 or the enhanced wireless RF thermostats 14.

Since the two systems share the same radio technology, the wireless RF security alarm system and the wireless RF HVAC system can provide access to features now available from both systems. For example, the selection of which HVAC sensor information to use can be determined by room occupancy information provided by the room occupancy motion sensors 36, typically IR sensors for sensing the presence of an occupant of a room, of the security alarm system. The combination of the two systems can provide an automatic control of the HVAC system based on the state of the security alarm system, such as to provide an automatic setback of the HVAC system based on the room occupancy sensors to provide energy savings of the HVAC system, or in embodiments wherein the security system includes a CO sensor 15 and a smoke or fire detector 17, and the HVAC system does not, to turn off the HVAC system during a fire event, or to turn on the HVAC system during a CO event.

The security system might also include a feature whereby an RF component allows a user to merely press a button to select a security armed condition when the user is leaving the premises or retiring to bed for the evening, and that command could be communicated to the HVAC system to place the HVAC system in a setback, energy conserving mode.

If a wireless RF security alarm system 12 is already installed in a home, the home owner might purchase an enhanced replacement thermostat 14 as described herein. All of the above features could be options in buying and installing an improved wireless RF HVAC control system. Since the two systems share a common radio technology, the security alarm system and the HVAC system can detect the presence of each other and provide access to the features described herein which are now available because of the combination of the two systems.

This feature of a common RF technology permits controls for HVAC systems and controls for security alarm systems to interact without requiring special installations between the two diverse systems or special programming requirements.

The interconnected HVAC system and security system need not include an extensive number of RF components. For instance the interconnected HVAC system might include a single RF component to enable it to communicate with the security system, or the interconnected security system might include a single RF component to enable it to communicate with the HVAC system.

The creation of this ad hoc RF infrastructure can be expanded with additional user or manufacturer installed devices that require an infrastructure for display and/or communications. For example, a car could send a wireless RF signal that it is low on gas or has low tire pressure to remind a person who is arming the security alarm system when leaving the house. Similarly, a wireless RF controlled appliance might require service. The RF infrastructure could also be used to communicate with these devices to take appropriate action.

Since some of these subsystems may include wide area communications means (e.g. the security alarm system may provide internet connectivity and remote control), this RF infrastructure can extend remote control of all its devices to the internet. Most of these features can be accomplished with minimal user set up and with simplicity, often permitting do-it-yourself installation.

One of the strengths of this approach is that each of the subsystems retains its own market channels and installers to create a “whole is greater than the sum of its parts” system automatically by using compatible RF transceiver technology.

When the wireless RF HVAC system has more than one zone and more than one wireless RF thermostat, the different wireless RF thermostats 14 can discover the presence of each other and permit adjustment and display of any one thermostat's conditions from any of the other thermostats, such as, for example, to permit the RF thermostat of zone 1 to display the conditions of the RF thermostat of zone 2 and to control the controller 18 of zone 2.

Moreover, additional wireless RF temperature sensors 34 can be added to other rooms in the home. One of the common problems of conventional systems is that adjusting the temperature in one room does not necessarily make it comfortable in the room presently being occupied. The present invention can include multiple room wireless temperature sensors 34 and a remote control to permit a user to instruct the HVAC system to use the information from a particular temperature sensor 34 or from a room presently being occupied, thereby making the occupied room comfortable.

A wireless RF thermostat could be designed to select a particular mode of operation and can be installed near the house entrance or in a bedroom. For example, when leaving, one could select an “away” mode by a control 38 that would send a signal, thus triggering selected temperature settings (e.g., setbacks) for the desired mode. At night, one could select a temperature “night” mode by a control 40 to set back the thermostats around the house.

One or more of the wireless RF thermostats or wireless RF remotes can also incorporate an easily programmable feature whereby, by merely pressing a button switch 36 one or more times, the temperature of the zone controlled by the thermostat or wireless remote can be set back for a period of time determined by the number of times the switch is depressed. For instance, each pressing of the switch can set back the temperature setting for one hour, or two or more hours, such that a set back period of a selected number of hours is selected by pressing the switch a given number of times. Moreover, that command of the easily programmable switch can be communicated to the security system to arm the security system during the set back period.

Each wireless RF remote control can be a simple battery powered device, or a rechargeable device, or a device mounted on the wall that is AC powered when mounted on the wall and battery operated when removed from its mounting and used in a mobile mode.

A wireless RF remote control device could also include a TV channel modulator or NTSC output to permit display of the condition of the HVAC system or the security alarm system on a conventional TV display.

A wireless, solar powered outdoor temperature sensor 42 can also be added. The outdoor temperature sensor can be placed anywhere outdoors on the premises, and an indoor wireless RF thermostat 14 could sense its presence and be able to display its information on its GUI 20. Indoor air quality sensors could be added in a similar fashion.

While several embodiments and variations of the present invention for an RF interconnected HVAC system and security system are described in detail herein, it should be apparent that the disclosure and teachings of the present invention will suggest many alternative designs to those skilled in the art.

1. An interconnected HVAC (heating, ventilating, air conditioning) system and security alarm system comprising:
the HVAC system incorporating a wireless RF (radio frequency) control system using a selected RF frequency, modulation and set of protocols, including at least one wireless RF HVAC control having an RF transceiver for communicating with and controlling the HVAC system;
the security alarm system incorporating a wireless RF control system using the same selected RF frequency, modulation and a set of common protocols as the HVAC RF wireless control system, and including at least one wireless RF security control for communicating with and controlling the security alarm system;
wherein the common same RF frequency, modulation and set of common protocols provide interconnectivity and communication between the HVAC system and the security alarm system.

2. The system of claim 1, wherein the HVAC system is controllable by the at least one wireless RF security control.

3. The system of claim 1, wherein the security alarm system is controllable by the at least one wireless RF HVAC control.

4. The system of claim 1, wherein the security alarm system includes room occupancy sensors, and the room occupancy sensors of the security alarm system are used to control the HVAC system.

5. The system of claim 4, wherein a wireless RF control can instruct the HVAC system to use information from a temperature sensor from a room presently being occupied, as determined by the room occupancy sensors of the security alarm system.

6. The system of claim 1, wherein the HVAC system turns itself off when a smoke or fire detector of the security alarm system reports a fire event.

7. The system of claim 1, wherein the HVAC system turns itself on when a CO sensor of the security alarm system reports a CO event.

8. The system of claim 1, wherein an RF security control allows a user to select a security armed condition when the user is leaving the premises or retiring for the evening, and that command is communicated to the HVAC system to place the HVAC system in a setback, energy conserving mode.

9. The system of claim 1, wherein the HVAC system includes a plurality of zones and a plurality of wireless RF HVAC controls which comprise wireless RF thermostats, and each wireless RF thermostat can discover each other wireless RF thermostat, to permit adjustment and display of any one wireless RF thermostat's conditions from any of the other wireless RF thermostats.

10. The system of claim 1, wherein each wireless RF HVAC includes a GUI (graphical user interface).

11. The system of claim 1, wherein the HVAC system has a plurality of wireless RF controls comprising wireless RF thermostats, and each wireless RF thermostat permits display and control of any other wireless RF thermostat's conditions.

12. The system of claim 1, wherein the HVAC system includes at least one wireless RF temperature sensor.

13. The system of claim 1, wherein a wireless RF control includes a selection of at least one mode to send an RF signal to trigger a selected temperature setting for the selected mode.

14. The system of claim 1, including a wireless RF outdoor temperature sensor, wherein a wireless RF HVAC control can display the information of the wireless RF outdoor temperature sensor.

15. The system of claim 1, wherein a wireless RF HVAC control incorporates an easily programmable switch which can be activated one or more times to set back the temperature of a zone controlled by the wireless RF HVAC control for a period of time determined by the number of times the switch is depressed.

16. The system of claim 15, wherein a command generated by pressing of the easily programmable switch is communicated to the security system to arm the security system during the set back period.
